(19) United States
(12) Patent Application Publication
(10) Pub. No.: US 2003/0005646 A1
(43) Pub. Date: Jan. 9, 2003

(54) Surface modification of coated abrasives to enhance their adhesion in resin bond tools

(76) Inventor: James M. McHale JR., Worthington, OH (US)

Correspondence Address: Jerry K. Mueller, Jr., Mueller and Smith, LPA, 7700 Rivers Edge Drive, Columbus, OH, 43235, US

(21) Appl. No.: 09/901,159

(22) Filed: Jul. 9, 2001

(51) Int. Cl. C09C 1/68; C09K 3/14; B24D 3/00

(52) U.S. Cl. 51/298; 51/307; 51/309; 51/308; 51/293; 428/403; 428/404; 423/335

(57) ABSTRACT

The retention of metal-coated superabrasive particles in a resin bond matrix is improved by incorporating a silane coupling agent into a mixture of metal-coated superabrasive particles and resin bond matrix. The silane can incorporated by providing a metal-coated superabrasive particle treated with a silane coupling agent for adding to the resin bond matrix. Alternatively, the silane can reacted into the resin bond matrix and then the metal-coated superabrasive particles added. Both diamond and cubic boron nitride are useful in the invention.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention relates to resin-bonded grinding elements containing metal coated superabrasive particles or grit and more particularly to the use of silane coupling agents to facilitate the adhesion of the metal coatings to the resin bond material.

The coating of diamond and cubic boron nitride (CBN) with nickel, nickel-phosphorous alloys, cobalt, cobalt-phosphorous alloys, copper, and various combinations thereof is a standard procedure in the industry for enhancing retention of the abrasives in resin bonded tools and for enhancing the grinding operation. The coatings enhance the retention of the crystals in the resin bond by providing greater surface texture (also help with heat dissipation, lubrication, other minor factors). Grinding wheels are made from these abrasives by mixing the coated diamond with resin powders and other additives (SiC, Cu powders), pressing the mixture in a mold and heating to cure the resin.

The patent literature is replete in this field. See, for example, U.S. Pat. Nos. 2,411,867; 3,779,727; 3,957,461; 3,528,788; 3,955,324; 4,403,001; and 4,521,222; British Pat. No. 1,344,237; and German Pat. No. 2,218,932. U.S. Pat. Nos. 4,024,675 and 4,246,006 form aggregates of diamond grit in a metal matrix that includes silver and U.S. Pat. No. 4,239,502 dips diamond or cubic boron nitride (CBN) in a molten silver/manganese/zirconium brazing alloy. Some attempts have been made to enhance the adhesion of the abrasive-coating interface by deposition of a carbide-forming element under the Ni, Co, or Cu coating. (U.S. Pat. Nos. 5,232,469 and 5,024,680). Some attempts have also been made at improving the coating-resin interface, but all of these involve increasing the mechanical forces by roughening the surface of the coating (see for example U.S. Pat. Nos. 3,650,714 and 4,435,189; and Irish Patent No. 21,637).

Retaining the crystals in the bond is the major factor that determines the usable lifetime of a grinding wheel. Even with the metal coatings, the major failure mode for diamond grinding wheels is entire coated crystals pulled out from the resin bond. The bond between the coating and resin appears to be the weak link. Modifying the Ni or Cu coating so that chemical bonding, in addition to the mechanical bonding, occurs between the metal and resin would result in greatly improved adhesion of the crystals in the bond. This would impart a significant competitive advantage to tools made with such modified abrasives.

### BRIEF SUMMARY OF THE INVENTION

The retention of metal-coated superabrasive particles in a resin bond matrix is improved by incorporating a silane coupling agent into a mixture of metal-coated superabrasive particles and resin bond matrix. The silane can incorporated by providing a metal-coated superabrasive particle treated with a silane coupling agent for adding to the resin bond matrix. Alternatively, the silane can reacted into the resin bond matrix and then the metal-coated superabrasive particles added. Both diamond and cubic boron nitride are useful in the invention.

### DETAILED DESCRIPTION OF THE INVENTION

Silane coupling agents are known promoters of metal-polymer adhesion (see, for example, Mittal, K. L., Pure & Appl. Chem., 1980, 52, 1295). Examples of such references in the patent literature include, for example, Vorse, et al. (U.S. Pat. No. 5,728,203), which describes an aqueous silane composition for coating a metallic substrate that can be used to provide a pre-treatment layer for adhering polymer overcoats; Harris, et al. (U.S. Pat. No. 5,668,210), which describes a coating composition comprising a hydrolyzed or partially hydrolyzed alkoxysilane, a solvent, and an arylcyclobutene, for use in coatings for multi-chip modules, flat panel displays and integrated circuits.

There are numerous silane coupling agents, which could serve as adhesion promoters between metal coated superabrasives and, for example, phenolic or polyimide resin bonds. One promising coupling agent for promoting nickel-phenolic resin adhesion is the water soluble silane bis-[trimethoxysilylpropyl]amine (BTMSPA). To enhance adhesion in a resin bond, Ni-coated diamonds could be added to an aqueous solution of BTMSPA, collected (e.g., on a sieve), washed with distilled water, and dried. A coating of the BTMSPA would remain adhered by chemical bonds to the nickel coated diamonds. The treated diamonds could then be used in a standard resin-bond formulation for fabrication of tools. Typically, this involves mixing the coated diamond with resin powders and other additives (SiC, Cu powders), pressing the mixture in a mold and firing it to cure the resin. Ideally, the SiC and Cu additives would also be treated with appropriate coupling agents to improve the overall resin-filler-abrasive integrity in the bond. For copper coated diamonds, bis-[triethoxysilylpropyl]tetrasulfide should serve as an effective coupling agent. This compound bonds to copper by means of the sulfur atoms to form copper sulfides.

Additional known silanes include, inter alia, 3-aminopropyltriethoxysilane, N-[3-(trimethoxysilyl)propyl]ethylenediamine, gamma-glycidoxypropyltrimethoxysilane, beta-(3,4-epoxycyclohexyl)ethyltrimethoxy silane, tetramethylsilane, tetraethylsilane, tetramethoxysilane, methyltrimethoxysilane, dimethyldimethoxysilane, trimethylmethoxysilane, tetraethoxysilane, dimethyltetramethoxydisilazane, 1,1,3,3-tetramethyl-1,3-diethyoxysiloxane, 3-(2-aminoethyl)-aminopropyl trimethoxysilane, gamma-aminopropyl triethoxysilane, and glycidoxypropyl trimethoxysilane.

Finally, the silane itself can be modified to maximize the amount of chemical bonding with a particular resin system. For example, dissolving an appropriate silane in formaldehyde would functionalize the compound with aldehyde groups. These functional groups should then be able to take part in the polymerization reaction of a phenolic resin thereby creating strong chemical bonds between the coupling agent and the matrix.

The diamond particles can be natural or synthetic. Synthetic diamond most often is used in grinding operations. Synthetic diamond can be made by high pressure/high temperature (HP/HT) processes, which are well known in the art. The particle size of the diamond is conventional in size for resin-bond grinding wheels. Generally, the diamond grit can range in particle size from about 400 mesh (37 microns) upward to 40 mesh (425 microns). Narrow particle size distributions can be preferred according to conventional grinding technology. Cubic boron nitride (CBN) also can be coated in accordance with the precepts of the present invention; although, the beneficial affects of the silane coupling agents are not expected to be as pronounced as with diamond.

The resin most frequently used in resin bond grinding wheels is a phenol-formaldehyde reaction product. However, other resins or organic polymers may be used, such as, for example, melamine or urea formaldehyde resins, epoxy resins, polyesters, polyamides, and polyimides. Concentration of coated diamond and fabrication of such wheels is conventional and well known in that art. Broadly, such concentrations range from about 25 to 200 (100 concentration conventionally being defined in the art as 4.4 carats/cm³ with 1 carat equal to 0.2 g, wherein the concentration of diamond grains is linearly related to its carat per unit volume concentration). Preferably, the concentration of diamond grit ranges from about 50-100.

Grinding wheels can be disc shape or cup shape and can contain a secondary distribution of silicon carbide or other secondary abrasive particles without detrimentally affecting the performance of the grinding element containing the silver coated diamond particles. In a typical preparation of a resin bond grinding wheel, a mixture of granulated resin, Ag coated diamond abrasive particles, and filler is placed in a mold. A pressure appropriate to the particular resin, usually several thousand pounds per square inch (several tens of thousands of Kilo Pascals, KPa), is applied, and the mold is heated to a temperature sufficient to make the resin plastically deform (and cure when the resin is heat-curable).

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

1. Method for improving the retention of metal-coated superabrasive particles in a resin bond matrix, which comprises:
incorporating a silane coupling agent into a mixture of metal-coated superabrasive particles and resin bond matrix.

2. The method of claim 1, wherein said metal-coated superabrasive particles are treated with said silane and then added to said resin bond matrix.

3. The method of claim 1, wherein said silane is reacted into said resin bond matrix.

3. The method of claim 1, wherein said superabrasive particles are one or more of diamond particles or cubic boron nitride (CBN) particles.

4. The method of claim 1, wherein said metal coating is one or more of nickel, copper, cobalt, silver, or alloys thereof.

5. The method of claim 4, wherein said alloys comprise phosphorous alloys.

6. The method of claim 1, wherein said silane is one or more of bis-[trimethoxysilylpropyl]amine, bis-[triethoxysilyipropyl]tetrasulfide, 3-aminopropyltriethoxysilane, N-[3-(trimethoxysilyl)propyl]ethylenediamine, gamma-glycidoxypropyltrimethoxysilane, beta-(3,4-epoxycyclohexyl)ethyltrimethoxy silane, tetramethylsilane, tetraethylsilane, tetramethoxysilane, methyltrimethoxysilane, dimethyldimethoxysilane, trimethylmethoxysilane, tetraethoxysilane, dimethyltetramethoxydisilazane, 1,1,3,3-tetramethyl-1,3-diethyoxysiloxane, 3-(2-aminoethyl)-aminopropyl trimethoxysilane, gamma-aminopropyl triethoxysilane, or glycidoxypropyl trimethoxysilane.

7. The method of claim 1, wherein said resin bond matrix is one or more of a melamine formaldehyde resins, urea formaldehyde resins, epoxy resins, polyester resins, polyamide resins, or polyimide resins.

8. A metal-coated superabrasive particle having improved retention of in a resin bond matrix, which comprises:
a metal-coated superabrasive particle treated with a silane coupling agent.

9. The metal-coated superabrasive particle of claim 8, wherein said metal-coated superabrasive particle is added to a resin bond matrix.

10. The metal-coated superabrasive particle of claim 9, wherein said silane is reacted into said resin bond matrix.

11. The metal-coated superabrasive particle of claim 8, wherein said superabrasive particle is one or more of diamond particle or cubic boron nitride (CBN) particle.

12. The metal-coated superabrasive particle of claim 8, wherein said metal coating is one or more of nickel, copper, cobalt, silver, or alloys thereof.

13. The metal-coated superabrasive particle of claim 12, wherein said alloys comprise phosphorous alloys.

14. The metal-coated superabrasive particle of claim 8, wherein said silane is one or more of bis-[trimethoxysilylpropyl]amine, bis-[triethoxysilylpropyl]tetrasulfide, 3-aminopropyltriethoxysilane, N-[3-(trimethoxysilyl)propyl]ethylenediamine, gamma-glycidoxypropyltrimethoxysilane, beta-(3,4-epoxycyclohexyl)ethyltrimethoxy silane, tetramethylsilane, tetraethylsilane, tetramethoxysilane, methyltrimethoxysilane, dimethyidimethoxysilane, trimethylmethoxysilane, tetraethoxysilane, dimethyltetramethoxydisilazane, 1,1,3,3-tetramethyl-1,3-diethyoxysiloxane, 3-(2-aminoethyl)-aminopropyl trimethoxysilane, gamma-aminopropyl triethoxysilane, or glycidoxypropyl trimethoxysilane.

15. The metal-coated superabrasive particle of claim 9, wherein said resin bond matrix is one or more of a melamine formaldehyde resins, urea formaldehyde resins, epoxy resins, polyester resins, polyamide resins, or polyimide resins.

16. A mixture, which comprises:
(a) metal-coated superabrasive particle; and
(b) a resin bond matrix having a silane is reacted thereinto.

17. The mixture of claim 16, wherein said resin bond matrix is one or more of a metamine formaldehyde resins, urea formaldehyde resins, epoxy resins, polyester resins, polyamide resins, or polyimide resins.

18. The mixture of claim 16, wherein said silane is one or more of bis-[trimethoxysilylpropyl]amine, bis-[triethoxysilylpropyl]tetrasulfide, 3-aminopropyltriethoxysilane, N-[3-(trimethoxysilyl)propyl]ethylenediamine, gamma-glycidoxypropyltrimethoxysilane, beta-(3,4-epoxycyclohexyl)ethyltrimethoxy silane, tetramethylsilane, tetraethylsilane, tetramethoxysilane, methyltrimethoxysilane, dimethyidimethoxysilane, trimethylmethoxysilane, tetraethoxysilane, dimethyltetramethoxydisilazane, 1,1,3,3-tetramethyl-1,3-diethyoxysiloxane, 3-(2-aminoethyl)-aminopropyl trimethoxysilane, gamma-aminopropyl triethoxysilane, or glycidoxypropyl trimethoxysilane.

19. The mixture of claim 16, wherein said superabrasive particle is one or more of diamond particle or cubic boron nitride (CBN) particle.

20. The mixture of claim 16, wherein said metal coating is one or more of nickel, copper, cobalt, silver, or alloys thereof.
